(19) United States
(12) Patent Application Publication
(10) Pub. No.: US 2025/0046781 A1
(43) Pub. Date: Feb. 6, 2025

(54) BATTERY AND PRODUCTION METHOD FOR BATTERY

(71) Applicant: Panasonic Intellectual Property Management Co., Ltd., Osaka (JP)

(72) Inventors: SHUJI ITO, Nara (JP); TADAAKI MATSUMURA, Shiga (JP)

(21) Appl. No.: 18/924,862

(22) Filed: Oct. 23, 2024

Related U.S. Application Data
(63) Continuation of application No. PCT/JP2022/044225, filed on Nov. 30, 2022.

(30) Foreign Application Priority Data
May 16, 2022 (JP) 2022-080114

(51) Int. Cl. H01M 4/04; H01M 4/02; H01M 4/38; H01M 10/058; H01M 10/44

(52) U.S. Cl. CPC H01M 4/045; H01M 4/0404; H01M 4/386; H01M 10/058; H01M 10/44; H01M 2004/027

(57) ABSTRACT

The production method for a battery of the present disclosure includes: depositing silicon on a negative electrode current collector to produce a negative electrode; producing a laminated body including the negative electrode, a solid electrolyte layer, and a positive electrode in this order; and charging the laminated body to cause metallic lithium to precipitate in the negative electrode.

The battery of the present disclosure includes a positive electrode, a negative electrode, and a solid electrolyte layer located between the positive electrode and the negative electrode. The positive electrode contains a positive electrode active material containing lithium. The negative electrode contains a negative electrode active material containing metallic lithium and silicon. The ratio Ns/P of the charge capacity Ns of the silicon per unit area of the negative electrode to the charge capacity P per unit area of the positive electrode satisfies 0.3≤Ns/P≤0.96.

### BACKGROUND

### 1. Technical Field

The present disclosure relates to a battery and a method for producing the battery.

### 2. Description of the Related Art

Japanese Unexamined Patent Application Publication No. 2018-501615 discloses a rechargeable electrochemical cell including a nonaqueous fluid electrolyte, a negative electrode, a positive electrode, and an electronically insulating separator configured to separate the negative electrode and the positive electrode from each other, wherein the negative electrode and the positive electrode are configured such that the capacity of the negative electrode is strictly less than the capacity of the positive electrode.

### SUMMARY

One non-limiting and exemplary embodiment provides a battery with a suitable balance between energy density and cycle characteristics.

In one general aspect, the techniques disclosed here feature a production method for a battery including: depositing silicon on a negative electrode current collector to produce a negative electrode; producing a laminated body including the negative electrode, a solid electrolyte layer, and a positive electrode in this order; and charging the laminated body to cause metallic lithium to precipitate in the negative electrode.

The present disclosure provides a battery with a suitable balance between energy density and cycle characteristics.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a schematic structure of a battery in an embodiment; and

FIG. 2 is a flowchart showing a method for producing the battery in the embodiment.

### DETAILED DESCRIPTIONS

### Underlying Knowledge Forming Basis of the Present Disclosure

To address the rapid spread of electric vehicles, there is an urgent need to develop vehicle-mounted lithium secondary batteries having features such as high safety, high performance, and long life. Moreover, to improve the convenience of electric vehicles, there is a need to increase the cruising distance per charge and shorten the charging time. To allow lithium secondary batteries to have high energy density or high capacity, the development of high-capacity negative electrode materials is important. For example, metallic lithium and silicon are both promising high-capacity negative electrode materials.

Japanese Unexamined Patent Application Publication No. 2018-501615 discloses a rechargeable electrochemical cell including a nonaqueous fluid electrolyte, a negative electrode, a positive electrode, and an electronically insulating separator configured to separate the negative electrode and the positive electrode from each other, wherein the negative electrode and the positive electrode are configured such that the capacity of the negative electrode is strictly less than the capacity of the positive electrode. In the rechargeable electrochemical cell in Japanese Unexamined Patent Application Publication No. 2018-501615, the negative electrode and the positive electrode are configured such that the capacity of the negative electrode is strictly less than the capacity of the positive electrode.

When metallic lithium is used as a negative electrode active material, the energy density can be significantly increased. However, when metallic lithium is used as a negative electrode active material, the metallic lithium precipitates in a dendritic form during charging and pierces the solid electrolyte layer, and this may cause a short circuit between the negative electrode and the positive electrode.

Silicon largely expands or contracts during charging and discharging. Therefore, the cycle characteristics of a battery using silicon as a negative electrode active material are generally poor.

The present inventors have conducted extensive studies on the structure of a lithium solid-state battery with a suitable balance between energy density and cycle characteristics. Thus, the inventors have arrived at the battery of the disclosure.

### SUMMARY OF ASPECTS OF PRESENT DISCLOSURE

A production method for a battery according to a first aspect of the present disclosure includes:
depositing silicon on a negative electrode current collector to produce a negative electrode;
producing a laminated body including the negative electrode, a solid electrolyte layer, and a positive electrode in this order; and
charging the laminated body to cause metallic lithium to precipitate in the negative electrode.

According to the first aspect, a battery with a suitable balance between energy density and cycle characteristics can be produced.

According to a second aspect of the present disclosure, for example, in the production method for a battery according to the first aspect, the ratio Ns/P of the charge capacity Ns of the silicon per unit area of the negative electrode to the charge capacity P per unit area of the positive electrode may satisfy 0.3≤Ns/P≤0.96. According to the second aspect, a battery with a suitable balance between energy density and cycle characteristics can be produced.

According to a third aspect of the present disclosure, for example, in the production method for a battery according to the second aspect, the ratio Ns/P may satisfy 0.5≤Ns/P. With the production method configured as described above, the cycle characteristics of the battery can be improved.

According to a fourth aspect of the present disclosure, for example, in the production method for a battery according to the second aspect, the ratio Ns/P may satisfy Ns/P≤0.9. With the production method configured as described above, the battery with a suitable balance between energy density and cycle characteristics can be provided more reliably.

According to a fifth aspect of the present disclosure, for example, in the production method for a battery according to the first aspect, the negative electrode may include a negative electrode active material layer located between the negative electrode current collector and the solid electrolyte layer, and the negative electrode active material layer may have a structure in which a plurality of silicon particles are disposed along a surface of the negative electrode current collector so as to cover the surface of the negative electrode current collector. With the production method configured as described above, the cycle characteristics can be improved while the energy density is maintained at a relatively high level.

According to a sixth aspect of the present disclosure, for example, in the production method for a battery according to the fifth aspect, the silicon particles may be in a columnar form. With the production method configured as described above, the cycle characteristics can be improved while the energy density is maintained at a relatively high level.

According to a seventh aspect of the present disclosure, for example, in the production method for a battery according to the first aspect, the solid electrolyte layer may contain a solid electrolyte having lithium ion conductivity. With the production method configured as described above, a battery having both high capacity and good cycle characteristics can be obtained.

According to an eighth aspect of the present disclosure, for example, in the production method for a battery according to the seventh aspect, the solid electrolyte may contain a sulfide solid electrolyte. With the production method configured as described above, a battery having both high capacity and good cycle characteristics can be obtained.

A method of using a battery according to a ninth aspect of the present disclosure includes charging a battery including a laminated body including a negative electrode prepared by depositing silicon on a negative electrode current collector, a solid electrolyte layer, and a positive electrode in this order to thereby cause metallic lithium to precipitate in the negative electrode. With the method of use configured as described above, the energy density and cycle characteristics of the battery can be balanced with each other.

According to a tenth aspect of the present disclosure, for example, in the method of using a battery according to the ninth aspect, the ratio Ns/P of the charge capacity Ns of the silicon per unit area of the negative electrode to the charge capacity P per unit area of the positive electrode may satisfy 0.3≤Ns/P≤0.96. With the method of use configured as described above, the energy density and cycle characteristics of the battery can be balanced with each other.

According to an eleventh aspect of the present disclosure, for example, in the method of using a battery according to the tenth aspect, the ratio Ns/P may satisfy 0.5≤Ns/P. With the method of use configured as described above, the cycle characteristics of the battery can be improved.

According to a twelfth aspect of the present disclosure, for example, in the method of using a battery according to the tenth aspect, the ratio Ns/P may satisfy Ns/P≤0.9.

With the method of use configured as described above, the energy density and cycle characteristics of the battery can be balanced with each other.

According to a thirteenth aspect of the present disclosure, for example, in the method of using a battery according to the ninth aspect, the negative electrode may include a negative electrode active material layer located between the negative electrode current collector and the solid electrolyte layer, and the negative electrode active material layer may have a structure in which a plurality of silicon particles are disposed along a surface of the negative electrode current collector so as to cover the surface of the negative electrode current collector. With the method of use configured as described above, the cycle characteristics of the battery can be improved while the energy density is maintained at a relatively high level.

According to a fourteenth aspect of the present disclosure, for example, in the method of using a battery according to the thirteenth aspect, the silicon particles may be in a columnar form. With the method of use configured as described above, the cycle characteristics of the battery can be improved while the energy density is maintained at a relatively high level.

A battery according to a fifteenth aspect includes:
a positive electrode;
a negative electrode, and
a solid electrolyte layer located between the positive electrode and the negative electrode,
wherein the positive electrode contains a positive electrode active material containing lithium,
wherein the negative electrode contains a negative electrode active material containing metallic lithium and silicon, and
wherein the ratio Ns/P of the charge capacity Ns of the silicon per unit area of the negative electrode to the charge capacity P per unit area of the positive electrode satisfies 0.3≤Ns/P≤0.96.

According to the fifteenth aspect, the battery can have a suitable balance between energy density and cycle characteristics.

According to a sixteenth aspect of the present disclosure, for example, in the battery according to the fifteenth aspect, the negative electrode may include a negative electrode current collector and a negative electrode active material layer located between the negative electrode current collector and the solid electrolyte layer, and the negative electrode active material layer may have a structure in which a plurality of silicon particles are disposed along a surface of the negative electrode current collector so as to cover the surface of the negative electrode current collector. The cycle characteristics of the battery can thereby be improved while the energy density is maintained at a relatively high level.

According to a seventeenth aspect of the present disclosure, for example, in the battery according to the fifteenth aspect, the metallic lithium may precipitate during charging. The battery configured as described above can have a suitable balance between energy density and cycle characteristics.

A battery according to an eighteenth aspect includes:
a positive electrode;
a negative electrode, and
a solid electrolyte layer located between the positive electrode and the negative electrode,
wherein the positive electrode contains a positive electrode active material containing lithium,
wherein the negative electrode contains a negative electrode active material containing metallic lithium and silicon, and
wherein the ratio Ns/P of the charge capacity Ns of the silicon per unit area of the negative electrode to the charge capacity P per unit area of the positive electrode satisfies 0.3≤Ns/P≤0.96.

In the eighteenth aspect, since the ratio Ns/P satisfies 0.3≤Ns/P≤0.96, the battery provided can have a suitable balance between energy density and cycle characteristics.

According to a nineteenth aspect of the present disclosure, for example, in the battery according to the eighteenth aspect, the ratio Ns/P may satisfy 0.5≤Ns/P. In the battery configured as descried above, the cycle characteristics are improved.

According to a twentieth aspect of the present disclosure, for example, in the battery according to the eighteenth aspect, the ratio Ns/P may satisfy Ns/P≤0.9. The battery configured as descried above can more reliably have a suitable balance between energy density and cycle characteristics.

According to a twenty-first aspect of the present disclosure, for example, in the battery according to any one of the eighteenth to twentieth aspects, the negative electrode may include a negative electrode current collector and a negative electrode active material layer located between the negative electrode current collector and the solid electrolyte layer, and the negative electrode active material layer may have a structure in which a plurality of silicon particles are disposed along a surface of the negative electrode current collector so as to cover the surface of the negative electrode current collector. In the battery configured as described above, the cycle characteristics can be improved while the energy density is maintained at a relatively high level.

According to a twenty-second aspect of the present disclosure, for example, in the battery according to the twenty-first aspect, the silicon particles may be in a columnar form. In the battery configured as described above, the cycle characteristics can be improved while the energy density is maintained at a relatively high level.

According to a twenty-third aspect of the present disclosure, for example, in the battery according to any one of the eighteenth to twenty-second aspects, the solid electrolyte layer may contain a solid electrolyte having lithium ion conductivity. The battery configured as described above can have both high capacity and good cycle characteristics.

According to a twenty-fourth aspect of the present disclosure, for example, in the battery according to the twenty-third aspect, the solid electrolyte may contain a sulfide solid electrolyte. The battery configured as described above can have both high capacity and good cycle characteristics.

A production method for a battery according to a twenty-fifth aspect of the present disclosure includes:
depositing silicon on a negative electrode current collector to produce a negative electrode;
producing a laminated body including the negative electrode, a solid electrolyte layer, and a positive electrode in this order; and
charging the laminated body to cause metallic lithium to precipitate in the negative electrode.

According to the twenty-fifth aspect, a battery with a suitable balance between energy density and cycle characteristics can be produced.

Embodiments of the present disclosure will be described with reference to the drawings. However, the present disclosure is not limited to the following embodiments.

### EMBODIMENTS

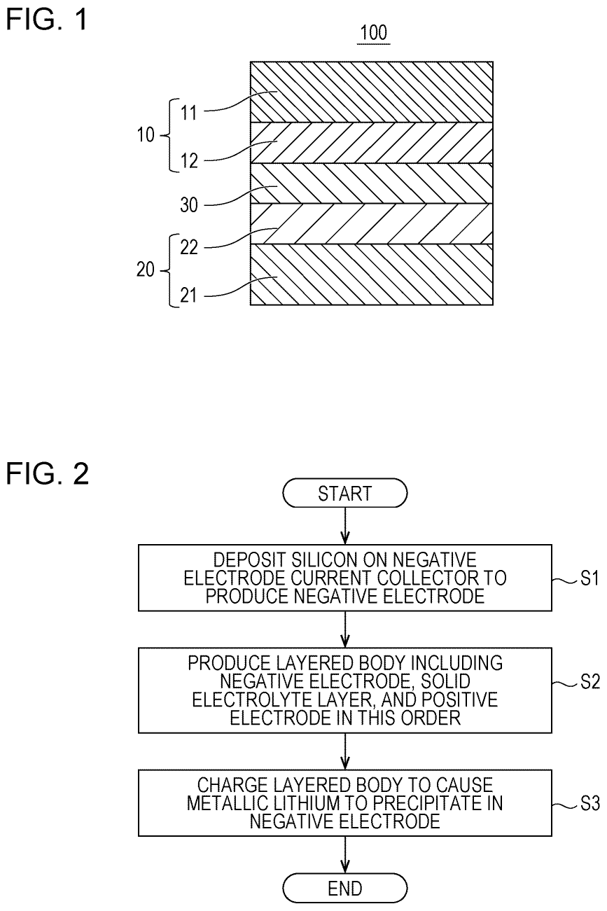

FIG. 1 is a cross-sectional view showing a schematic structure of a battery 100 in an embodiment. The battery 100 includes a positive electrode 10, a negative electrode 20, and a solid electrolyte layer 30 located between the positive electrode 10 and the negative electrode 20. The positive electrode 10 contains a positive electrode active material containing lithium. The negative electrode 20 contains a negative electrode active material containing metallic lithium and silicon. The ratio Ns/P of the charge capacity Ns of silicon per unit area of the negative electrode to the charge capacity P per unit area of the positive electrode 10 satisfies 0.3≤Ns/P≤0.96.

When the ratio Ns/P is less than 1, lithium contained in the positive electrode 10 moves to the negative electrode during a charging process and precipitates in the negative electrode 20. In this manner, the negative electrode active material containing metallic lithium and silicon is formed. The closer the ratio Ns/P to 1, the higher the ratio of the capacity derived from silicon to the capacity of the battery. The closer the ratio Ns/P to 0, the higher the ratio of the capacity derived from metallic lithium to the capacity of the battery. In the battery 100 in the present embodiment, since the ratio Ns/P is more than or equal to 0.3, the amount of metallic lithium contained in the negative electrode 20 is limited. Therefore, although lithium precipitates in the negative electrode 20, the occurrence of a short circuit between the negative electrode 20 and the positive electrode 10 due to the metallic lithium precipitated in a dendritic form is prevented. Since the ratio Ns/P satisfies 0.3≤Ns/P≤0.96, the energy density and the cycle characteristics are balanced with each other. One reason for this is that, in the negative electrode 20, the silicon and the precipitated metallic lithium function as the negative electrode active material. Another possible reason is as follows. When the negative electrode active material contains only metallic lithium, lithium ions move from the negative electrode to the positive electrode during a discharging process. In a fully discharged state, no or almost no lithium is present in the negative electrode. In the battery 100, the negative electrode active material contains metallic lithium and silicon. Therefore, even in a fully discharged state, silicon is present in the negative electrode 20. The silicon present in the negative electrode 20 and the metallic lithium precipitated around the silicon may cooperate together to improve the retention rate of discharge capacity. Specifically, in the battery 100, the silicon and the precipitated metallic lithium function as the negative electrode active material. In addition, the silicon serves as a filler in the negative electrode 20, and the metallic lithium precipitated around the silicon serves as an electron conducting material. This may improve the balance between the energy density and the cycle characteristics.

The ratio Ns/P may satisfy 0.5≤Ns/P. In this case, the cycle characteristics of the battery 100 are improved. Moreover, since the amount of metallic lithium contained in the negative electrode 20 is further limited, the occurrence of a short circuit between the negative electrode 20 and the positive electrode 10 due to the metallic lithium precipitated in a dendritic form can be further prevented.

The ratio Ns/P may satisfy Ns/P≤0.9. In this case, a reduction in the energy density that occurs when the capacity derived from silicon in the negative electrode active material occupies most of the battery capacity can be prevented. Moreover, since the capacity derived from metallic lithium is guaranteed, a reduction in current collectability by silicon due to a reduction in the amount of the metallic lithium precipitated around the silicon during a charging process can be prevented, and a reduction in the cycle characteristics due to the reduction in the current collectability can be prevented. Therefore, the battery 100 with a suitable balance between energy density and cycle characteristics can be provided more reliably.

The ratio Ns/P may satisfy 0.5≤Ns/P≤0.96, may satisfy 0.3≤Ns/P≤0.9, may satisfy 0.53≤Ns/P≤0.96, or may satisfy 0.53≤Ns/P≤0.9.

The ratio Ns/P is determined by dividing the charge capacity Ns (mAh/cm²) of silicon per unit area of the negative electrode 20 by the charge capacity P (mAh/cm²) per unit area of the positive electrode 10.

The charge capacity Ns of silicon per unit area of the negative electrode 20 can be determined, for example, by the following method. First, a half-cell including a silicon-made negative electrode serving as a working electrode and a counter electrode using metallic lithium or indium lithium is produced. Next, the half-cell is charged at a current rate of 0.05 C to 0 V with respect to the potential of the metallic lithium to measure the initial charge capacity (mAh). A value obtained by converting the initial charge capacity to a capacity per unit mass of silicon is defined as A_{Ns} (mAh/g). The mass of silicon contained in a unit area of the negative electrode 20 is defined as B_{Ns} (mg/Cm²). The product of A_{Ns} (mAh/g) and B_{Ns} (mg/cm²) is used to compute the charge capacity Ns of silicon per unit area of the negative electrode 20 (mAh/cm²).

When the positive electrode active material has an average discharge potential of around 3.7 V vs Li/Li⁺ with respect to the oxidation-reduction potential of metallic lithium, the charge capacity P per unit area of the positive electrode 10 can be determined, for example, by the following method. The above positive electrode active material is, for example, a lithium-containing transition metal oxide such as Li(Ni,Co,Al)O₂, Li(Ni,Co,Mn)O₂, LiCoO₂, or LiMn₂O₄. First, a half-cell including a positive electrode formed of the positive electrode active material and serving as a working electrode and a counter electrode using metallic lithium or indium lithium is produced. Next, the half-cell is charged at a current rate of 0.05 C to 4.3 V with respect to the potential of the metallic lithium to measure the initial charge capacity (mAh). A value obtained by converting the initial charge capacity to a capacity per unit mass of the positive electrode active material is defined as A_{P} (mAh/g). The mass of the positive electrode active material contained in a unit area of the positive electrode 10 is defined as B_{P} (mg/cm²). The product of A_{P}(mAh/g) and B_{P} (mg/cm²) is used to compute the charge capacity P (mAh/cm²) per unit area of the positive electrode 10. When the positive electrode active material has an average discharge potential of around 3.4 V vs Li/Li⁺ with respect to the oxidation-reduction potential of metallic lithium, the charge capacity P can be determined, for example, by the following method. The above positive electrode active material is, for example, LiFePO₄. First, a half-cell including a positive electrode formed of the positive electrode active material and serving as a working electrode and a counter electrode using metallic lithium or indium lithium is produced. Next, the half-cell is charged at a current rate of 0.05 C to 3.9 V with respect to the potential of the metallic lithium to measure the initial charge capacity (mAh). A value obtained by converting the initial charge capacity to a capacity per unit mass of the positive electrode active material is defined as A_{P}(mAh/g). The mass of the positive electrode active material contained in a unit area of the positive electrode 10 is defined as B_{P} (mg/cm²). The product of A_{P} (mAh/g) and B_{P}(mg/cm²) is used to compute the charge capacity P (mAh/cm²) per unit area of the positive electrode 10.

In the present disclosure, the notation “(A,B,C)” in a chemical formula means “at least one selected from the group consisting of A, B, and C.” For example, “(Ni,Co,Al)” is synonymous with “at least one selected from the group consisting of Ni, Co, and Al.” The same applies to other elements.

The negative electrode 20 includes a negative electrode current collector 21 and a negative electrode active material layer 22. The negative electrode active material layer 22 is located between the negative electrode current collector 21 and the solid electrolyte layer 30. The negative electrode active material layer 22 contains the negative electrode active material.

The negative electrode active material layer 22 may contain substantially only the negative electrode active material. Specifically, the negative electrode active material layer 22 may contain substantially only metallic lithium and silicon. In the present disclosure, the phrase “contain substantially only ***” is intended mean that a trace amount of unavoidable impurities is allowed to be mixed.

At the time of assembly of the battery 100 or before the initial charging of the battery 100, the negative electrode active material layer 22 may contain no metallic lithium. In the present embodiment, since the ratio Ns/P satisfies 0.3≤Ns/P≤0.96, lithium in the positive electrode 10 moves through the solid electrolyte layer 30 during the charging process and precipitates in the negative electrode active material layer 22 containing silicon. The negative electrode active material layer 22 containing metallic lithium and silicon may be formed in the manner described above. Silicon itself has the ability to store lithium. Therefore, first, lithium is stored in silicon, and the rest of the lithium not stored in silicon precipitates at the surface of the silicon and the surface of the negative electrode current collector 21. The negative electrode active material layer 22 containing metallic lithium and silicon may also be formed in the manner described above.

The negative electrode active material layer 22 may have a structure in which a plurality of silicon particles are disposed along the surface of the negative electrode current collector 21 so as to cover the surface. In other words, the negative electrode active material layer 22 may be formed as a collection of the plurality of silicon particles covering the surface of the negative electrode current collector 21. With this structure, the solid electrolyte layer 30 is unlikely to come into contact with the negative electrode current collector 21. Therefore, the cycle characteristics of the battery 100 can be improved while the energy density is maintained at a relatively high level.

In the present embodiment, for example, one surface of the negative electrode current collector 21 has an uneven structure. Specifically, the negative electrode current collector 21 may have a plurality of protrusions and a plurality of recesses on one surface. The plurality of protrusions and the plurality of recesses may be arranged irregularly or regularly.

The silicon particles may be in a columnar form. In this case, the cycle characteristics of the battery 100 can be improved while the energy density is maintained at a relatively high level.

The plurality of columnar silicon particles may be formed so as to extend outward from one surface of the negative electrode current collector 21. The plurality of columnar silicon particles may extend in the same direction or in different directions. The plurality of columnar silicon particles may be supported by respective protrusions of the negative electrode current collector 21. However, the silicon particles are not necessarily limited to the columnar particles extending outward from one surface of the negative electrode current collector 21 and to the columnar particles supported by the protrusions of the negative electrode current collector 21. The silicon particles may further include, for example, silicon particles disposed on the columnar particles. The shape of the columnar silicon particles is not limited to a specific shape. The columnar silicon particles do not necessarily have a columnar shape. The columnar silicon particles may be spherical, needle-shaped, or ellipsoidal particles. The size of the columnar silicon particles is not limited to a specific size.

The plurality of columnar silicon particles may be formed on one surface of the negative electrode current collector 21 so as to be spaced from each other. When the negative electrode active material layer 22 is divided into a plurality of portions by gaps or cuts, the divided portions are each referred to as a column. In other words, the negative electrode active material layer 22 may be formed as a collection of the plurality of columnar silicon particles spread over one surface of the negative electrode current collector 21. With this structure, a substance that may diffuse from the solid electrolyte layer 30 during charging or discharging, react with the negative electrode current collector 21, and serve as a resistance to ionic conduction is unlikely to be generated. Moreover, since lithium ion conduction paths are formed in a silicon continuous phase formed from the plurality of columnar silicon particles, lithium ions can easily migrate inside the negative electrode active material layer 22. Therefore, the battery 100 obtained can more reliably have good cycle characteristics.

The content of silicon in the silicon particles may be more than or equal to 80% by mass and may be more than or equal to 95% by mass. In this case, the lithium occlusion ability of silicon can be sufficiently guaranteed. The content of silicon can be determined, for example, by inductive coupling plasma emission analysis.

The thickness of the negative electrode active material layer 22 is, for example, greater than or equal to 1 μm. The upper limit of the thickness of the negative electrode active material layer 22 may be 50 μm or may be 30 μm. In this case, the initial discharge capacity of the battery 100 is unlikely to decrease.

The thickness of the negative electrode active material layer 22 can be measured, for example, by the following method. A cross section of the negative electrode active material layer 22 is observed under a scanning electron microscope (SEM). The cross section is parallel to the laminating direction of the layers and includes the center of mass of the negative electrode active material layer 22 in plan view. Five points are arbitrarily selected from the obtained cross-sectional SEM image. The thickness of the negative electrode active material layer 22 is measured at each of the five arbitrarily selected points. The average of the measurements is regarded as the thickness of the negative electrode active material layer 22.

The width of the columnar silicon particles in the negative electrode active material layer 22 is, for example, greater than or equal to 3 μm and less than or equal to 30 μm. The width of a columnar silicon particle is the length of the column in a direction orthogonal to the laminating direction of the negative electrode current collector 21 and the negative electrode active material layer 22.

The width of the columnar silicon particles can be measured, for example, by the following method. A cross section of the negative electrode active material layer 22 is observed under a scanning electron microscope (SEM). The cross section is perpendicular to the laminating direction of the layers and includes the center of mass of the negative electrode active material layer 22 in side view. Ten columnar particles are arbitrarily selected from the obtained cross-sectional SEM image. The maximum width of each of the ten arbitrarily selected columnar particles is measured. The average of the measurements is regarded as the width of the columnar silicon particles.

The negative electrode active material layer 22 may contain amorphous silicon. In the present disclosure, the term “amorphous” is not limited to a material having no crystalline structure at all but is intended to include materials having crystalline regions in a short range order. The amorphous material means, for example, a material that does not show a sharp peak derived from a crystalline structure in X-ray diffraction (XRD) but shows a broad peak derived from the amorphous structure. In the present disclosure, the phrase “contains amorphous silicon” means that at least part of the negative electrode active material layer 22 contains amorphous silicon. From the viewpoint of lithium ion conductivity, all the silicon contained in the negative electrode active material layer 22 may be amorphous.

The negative electrode active material layer 22 may contain no crystalline silicon. The silicon contained in the negative electrode active material layer 22 may be composed substantially of amorphous silicon or may contain only amorphous silicon. For example, when the negative electrode active material layer 22 is a thin film, XRD measurement is performed at a plurality of arbitrarily selected positions (for example, 5 points) of the thin film. When no sharp peak is observed at all the measurement points, it can be judged that all the silicon contained in the negative electrode active material layer 22 is amorphous silicon or is composed substantially of amorphous silicon or that the negative electrode active material layer 22 contains only amorphous silicon.

In the battery 100, the negative electrode active material layer 22 may contain an electrolyte as a result of charging or discharging. Specifically, during charging or discharging, part of the electrolyte contained in the solid electrolyte layer 30 may move from the solid electrolyte layer 30 to the negative electrode active material layer 22. However, immediately after the assembly of the battery 100 or before the initial charging and discharging, the negative electrode active material layer 22 may contain no electrolyte. With this structure, the content of silicon serving the negative electrode active material in the negative electrode active material layer 22 can be increased, so that the battery 100 obtained can have high energy density. Moreover, when the negative electrode active material layer 22 contains substantially no solid electrolyte, e.g., no sulfide solid electrolyte, the degree of contact between the metal in the negative electrode current collector 21 and the sulfide solid electrolyte can be small. Therefore, the generation of sulfides during charging or discharging of the battery 100 can be reduced. In this case, the charge-discharge rate characteristics and cycle characteristics of the battery 100 provided can be maintained for a long time. In the present disclosure, the phrase “contains no electrolyte” is intended to mean that a trace amount of the electrolyte is allowed to be mixed, and the amount of the electrolyte mixed with respect to the total mass of the negative electrode active material layer 22 is less than or equal to 5% by mass, but this depends, for example, on the number of charge-discharge cycles. In the present disclosure, the term “electrolyte” is intended to include solid electrolytes and nonaqueous electrolytes.

The material of the negative electrode current collector 21 is typically a metal. Examples of the material of the negative electrode current collector 21 include copper, nickel, stainless steel, and alloys containing any of these metals as a main component. The negative electrode current collector 21 may contain at least one selected from the group consisting of copper and nickel or may contain copper. The negative electrode current collector 21 may contain copper or nickel as a main component or may contain copper as a main component. With this structure, the battery 100 having high energy density can be obtained more reliably. In the present disclosure, the term “main component” means a component with the largest mass ratio.

The negative electrode current collector 21 used may be a metal foil. Examples of the metal foil include a copper foil and a nickel foil. The copper foil or the nickel foil may be an electrolytic foil. The electrolytic foil can be produced, for example, by the following method. First, a metal-made drum is immersed in an electrolyte solution containing copper or nickel ions dissolved therein. A current is applied while the metal-made drum is rotated. Copper or nickel thereby precipitates on the surface of the drum. The electrolytic foil is obtained by peeling off the precipitated copper or nickel. One or both sides of the electrolytic foil may be subjected to roughening treatment or surface treatment.

The surface of the negative electrode current collector 21 may or may not be roughened. With the negative electrode current collector 21 having a roughened surface, columnar silicon particles are easily formed on the surface of the negative electrode current collector 21, and the adhesion between the columnar silicon particles and the negative electrode current collector 21 is improved. Examples of the method for roughening the surface of the negative electrode current collector 21 include a method in which an electrolytic method is used to cause a metal to precipitate on the surface to thereby obtain a roughened metal surface.

The arithmetic mean roughness Ra of the surface of the negative electrode current collector 21 is, for example, greater than or equal to 0.001 μm. The arithmetic mean roughness Ra of the surface of the negative electrode current collector 21 may be greater than or equal to 0.01 μm and less than or equal to 1 μm or may be greater than or equal to 0.1 μm and less than or equal to 0.5 μm. By appropriately adjusting the arithmetic mean roughness Ra of the surface of the negative electrode current collector 21, the area of contact between the negative electrode current collector 21 and the negative electrode active material layer 22 can be increased. In this manner, the silicon particles contained in the negative electrode active material layer 22 are prevented from being separated from the negative electrode current collector 21. Therefore, the battery 100 can more reliably have good charge-discharge rate characteristics. The arithmetic mean roughness Ra is a value defined in the Japanese Industrial Standards (JIS) B0601: 2013 and can be measured, for example, using a laser microscope.

No particular limitation is imposed on the thickness of the negative electrode current collector 21. The thickness of the negative electrode current collector 21 may be, for example, greater than or equal to 5 μm and less than or equal to 50 μm or may be greater than or equal to 8 μm and less than or equal to 25 μm.

The solid electrolyte layer 30 contains a solid electrolyte having lithium ion conductivity. Examples of the solid electrolyte used for the solid electrolyte layer 30 include sulfide solid electrolytes, oxide solid electrolytes, halide solid electrolytes, complex hydride solid electrolytes, and polymeric solid electrolytes. With this structure, the battery 100 obtained can have both a high capacity and good cycle characteristics.

The sulfide solid electrolyte used may be Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂. LiX, Li₂O, MO_{q}, LiₚMO_{q}, etc. may be added to the sulfide solid electrolyte. The element X in “LiX” is at least one selected from the group consisting of F, Cl, Br, and I. The element M in “MOq” and “LipMOq” is at least one selected from the group consisting of P, Si, Ge, B, Al, Ga, In, Fe, and Zn. p and q in “MOq” and “LipMOq” are each independently a natural number.

Examples of the oxide solid electrolyte used include: NASICON solid electrolytes typified by LiTi₂(PO₄)₃ and element-substituted products thereof; (LaLi)TiO₃-based perovskite solid electrolytes; LISICON solid electrolytes typified by Li₁₄ZnGe₄O₁₆, Li₄SiO₄, and LiGeO₄ and element-substituted products thereof; garnet solid electrolytes typified by Li₇La₃Zr₂O₁₂ and element-substituted products thereof; Li₃N and H-substituted products thereof; Li₃PO₄ and N-substituted products thereof; glass containing a base material containing a Li—B—O compound such as LiBO₂ or Li₃BO₃ with a material such as Li₂SO₄ or Li₂CO₃ added thereto; and glass ceramics.

The halide solid electrolyte is represented, for example, by compositional formula (1) below. In compositional formula (1), a, J, and y are each independently a number larger than 0. M includes at least one selected from the group consisting of metal elements other than Li and semimetals. X includes at least one selected from the group consisting of F, Cl, Br, and I.

Li_{α}M_{β}X_{γ} formula (1)

The semimetal elements include B, Si, Ge, As, Sb, and Te. The metal elements include all elements included in groups 1 to 12 in the periodic table other than hydrogen and all elements included in groups 13 to 16 other than B, Si, Ge, As, Sb, Te, C, N, P, O, S, and Se. The metal elements are a group of elements, each of which can serve as a cation when it forms, together with a halogen compound, an inorganic compound.

The halide solid electrolyte used is Li₃YX₆, Li₂MgX₄, Li₂FeX₄, Li(Al,Ga,In)X₄, Li₃(Al,Ga,Jn)X₆, etc. The halide solid electrolyte exhibits good ionic conductivity.

Examples of the complex hydride solid electrolyte that can be used include LiBH₄—LiI and LiBH₄—P₂S₅.

The polymeric solid electrolyte used may be, for example, a compound prepared using a polymeric compound and a lithium salt. The polymeric compound may have an ethylene oxide structure. When the polymeric compound has the ethylene oxide structure, the polymeric compound can contain a large amount of the lithium salt, so that the ionic conductivity can be further improved. The lithium salt used may be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, etc. The lithium salt used may be one lithium salt selected from these lithium salts. Alternatively, the lithium salt used may be a mixture of two or more lithium salts selected from these lithium salts.

No particular limitation is imposed on the shape of the solid electrolyte contained in the solid electrolyte layer 30. For example, the solid electrolyte may have a needle shape, a spherical shape, an elliptical shape, etc. For example, the solid electrolyte may have a particle shape.

When the solid electrolyte contained in the solid electrolyte layer 30 has a particle shape (e.g., a spherical shape), the average particle diameter of the solid electrolyte particles is, for example, greater than or equal to 0.1 μm and less than or equal to 50 μm.

The average particle diameter of the solid electrolyte particles can be computed, for example, by the following method. A cross section of the solid electrolyte layer 30 is observed under a scanning electron microscope (SEM) or a transmission electron microscope (TEM), and the area of a specific solid electrolyte particle in the SEM or TEM image is computed using image analysis. The diameter of a circle having the same area as the computed area is regarded as the diameter of the specific solid electrolyte particle. The diameters of a given number (e.g., 10) of solid electrolyte particles are computed, and the average value is used as the average particle diameter of the solid electrolyte.

The positive electrode 10 includes a positive electrode current collector 11 and a positive electrode active material layer 12. The positive electrode active material layer 12 is located between the positive electrode current collector 11 and the solid electrolyte layer 30.

The material of the positive electrode current collector 11 is not limited to a specific material, and any material commonly used for batteries can be used. Examples of the material of the positive electrode current collector 11 include copper, copper alloys, aluminum, aluminum alloys, stainless steel, nickel, titanium, carbon, lithium, indium, and electrically conductive resins. The shape of the positive electrode current collector 11 is not limited to a specific shape. Examples of the shape include a foil shape, a film shape, and a sheet shape. Protrusions and recesses may be formed on the surface of the positive electrode current collector 11.

The positive electrode active material layer 12 contains a positive electrode active material containing lithium. The positive electrode active material has the ability to store and release metal ions such as lithium ions. Examples of the positive electrode active material include lithium-containing transition metal oxides, transition metal fluorides, polyanion materials, fluorinated polyanion materials, transition metal sulfides, transition metal oxysulfides, and transition metal oxynitrides.

Examples of the lithium-containing transition metal oxides include Li(Ni,Co,Al)O₂, Li(Ni,Co,Mn)O₂, and LiCoO₂. In particular, when the positive electrode active material used is, for example, a lithium-containing transition metal oxide, the production cost of the positive electrode can be reduced, and the average discharge voltage can be increased. To increase the energy density of the battery 100, the positive electrode active material may contain lithium nickel cobalt manganese oxide. The positive electrode active material may be, for example, Li(Ni,Co,Mn)O₂.

The positive electrode active material layer 12 may further optionally contain at least one selected from the group consisting of a solid electrolyte, a conductive assistant, and a binder. The positive electrode active material layer 12 may contain a material mixture of positive electrode active material particles and solid electrolyte particles.

No particular limitation is imposed on the shape of the positive electrode active material. The shape of the positive electrode active material may be a needle shape, a spherical shape, or an ellipsoidal shape. For example, the positive electrode active material has a particle shape.

When the positive electrode active material has a particle shape (e.g., a spherical shape), the average particle diameter of the positive electrode active material particles is, for example, greater than or equal to 100 nm and less than or equal to 50 μm. The average particle diameter of the positive electrode active material particles can be computed by the method described above for the solid electrolyte.

The average charge-discharge potential of the positive electrode active material may be greater than or equal to 3.7 V vs Li/Li⁺ with respect to the oxidation-reduction potential of metallic lithium. The average charge-discharge potential of the positive electrode active material can be determined, for example, from the average potential when lithium is intercalated into and deintercalated from the positive electrode active material with metallic lithium used as a counter electrode. When a material other than metallic lithium is used as the counter electrode, the average potential may be determined by adding the potential of the material used for the counter electrode with respect to the metallic lithium to the charge-discharge curve. When a material other than metallic lithium is used as the counter electrode, the battery may be charged and discharged using a relatively low current value in consideration of ohmic loss.

At least one selected from the group consisting of the positive electrode 10, the solid electrolyte layer 30, and the negative electrode 20 may contain a binder for the purpose of improving the adhesion between particles. The binder is used to improve, for example, the binding properties of the material forming the electrodes. Examples of the binder include polyvinylidene fluoride, polytetrafluoroethylene, polyethylene, polypropylene, aramid resins, polyamides, polyimides, polyamide-imides, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyethers, polyethersulfone, hexafluoropolypropylene, styrene-butadiene rubber, and carboxymethyl cellulose. The binder used may be a copolymer of at least two materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. The binder used may be a mixture of at least two materials selected from the above-described materials.

At least one selected from the group consisting of the positive electrode 10 and the negative electrode 20 may contain a conductive assistant for the purpose of improving electron conductivity. Examples of the conductive assistant include graphite, carbon black, conductive fibers, fluorinated carbon, metal powders, conductive whiskers, conductive metal oxides, and conductive polymers. Examples of the graphite include natural graphite and artificial graphite. Examples of the carbon black include acetylene black and Ketjen black. Examples of the conductive fibers include carbon fibers and metal fibers. Examples of the metal powder include aluminum. Examples of the conductive whisker include zinc oxide and potassium titanate. Examples of the conductive metal oxide include titanium oxide. Examples of the conductive polymer compound include polyaniline, polypyrrole, and polythiophene. When a conductive assistant containing carbon is used, a reduction in cost can be achieved.

No particular limitation is imposed on the operating temperature of the battery 100 in the present embodiment. The operating temperature is, for example, higher than or equal to −50° C. and lower than or equal to 100° C. The higher the operating temperature of the battery 100, the further the ionic conductivity can be improved, so that the battery 100 can be operated at higher power.

The area of the principal surface of the battery 100 is larger than or equal to 1 cm² and less than or equal to 100 cm². In this case, the battery 100 can be used for portable electronic devices such as smartphones and digital cameras. Alternatively, the area of the principal surface of the battery 100 may be larger than or equal to 100 cm² and less than or equal to 1000 cm². In this case, the battery 100 can be used for power sources of large-size mobile apparatuses such as electric vehicles. The “principal surface” means a surface of the battery 100 that has the largest area.

The battery 100 in the present embodiment may be formed as batteries with different shapes such as coin-shaped, cylindrical, square, sheet-shaped, button-shaped, flattened, and laminated batteries.

### Method for Producing Battery

The battery 100 in the present embodiment can be produced, for example, by the following method. FIG. 2 is a flowchart showing a production method for a battery in an embodiment. The production method for a battery in the embodiment includes: depositing silicon on the negative electrode current collector 21 to thereby produce the negative electrode 20 (step S1); producing a laminated body including the negative electrode 20, the solid electrolyte layer 30, and the positive electrode 10 in this order (step S2); and charging the laminated body to cause metallic lithium to precipitate in the negative electrode 20 (step S3).

First, in step S1, silicon is deposited on the negative electrode current collector 21 containing copper to produce the negative electrode 20. At this point, the negative electrode 20 contains no metallic lithium. The negative electrode current collector 21 used may have a surface roughened by precipitating copper by an electrolytic method. The surface of the electrolytic copper foil may be roughened. The electrolytic copper foil having a roughened surface can be produced by the following method. First, the electrolytic copper foil is produced by the method described above. The electrolytic method is further performed on the electrolytic copper foil to cause copper to precipitate on the surface of the electrolytic copper foil. The electrolytic copper foil having a roughened surface can thereby be obtained.

No particular limitation is imposed on the method for depositing silicon on the negative electrode current collector 21. For example, a chemical vapor deposition (CVD) method, a sputtering method, a vapor deposition method, a thermal spraying method, or a plating method may be used. A thin film may be formed by depositing silicon on the negative electrode current collector 21 using a vapor phase method such as a CVD method, a sputtering method, or a vapor deposition method. No particular limitation is imposed on the mass of silicon per unit area of the thin film. The mass of silicon per unit area of the thin film is, for example, greater than or equal to 0.1 mg/cm² and less than or equal to 5 mg/cm².

The thin film containing silicon can also be form by the following coating method. First, a coating solution containing silicon particles is prepared. The coating solution contains an organic solvent such as N-methylpyrrolidone (NMP). The coating solution may further contain a binder. The coating solution may be in the form of a paste. Next, the prepared coating solution is applied to the negative electrode current collector 21 to form a coating film. The coating film is subjected to drying treatment. A thin film containing silicon can thereby be formed. The conditions for the drying treatment for the coating film can be appropriately set according to the solvent contained in the coating solution etc. For example, the temperature of the drying treatment may be higher than or equal to 80° C. and lower than or equal to 150° C. The time of the drying treatment may longer than or equal to 1 hour and shorter than or equal to 24 hours.

In step S2, a laminated body including the negative electrode 20, the solid electrolyte layer 30, and the positive electrode 10 in this order is produced. The laminated body can be produced, for example, by the following method. First, a solid electrolyte powder is added to an electrically insulating cylinder. The solid electrolyte powder is pressed to form the solid electrolyte layer 30. Next, the negative electrode 20 produced is placed in the cylinder. Pressure is applied to the inside of the cylinder. A laminated body including the negative electrode 20 and the solid electrolyte layer 30 is thereby formed. Next, a positive electrode active material powder and the positive electrode current collector 11 are added to the cylinder. Pressure is applied to the inside of the cylinder. A laminated body including the negative electrode 20, the solid electrolyte layer 30, and the positive electrode 10 in this order can thereby be produced. Alternatively, the laminated body may be produced by placing the solid electrolyte powder, the positive electrode active material powder, and the positive electrode current collector 11, together with the negative electrode 20, in a cylinder and then applying pressure to the inside of the cylinder. In the laminated body, the negative electrode current collector 21, the thin film containing silicon, the solid electrolyte layer 30, and the positive electrode 10 are laminated in this order.

Next, an electrically insulating ferrule is used to seal and isolate the inside of the electrically insulating cylinder from the external environment.

In step S3, the laminated body is charged. During the charging, lithium ions migrate from the positive electrode 10 to the negative electrode 20. The lithium ions are stored in the silicon in the thin film formed on the negative electrode current collector 21. The rest of the lithium not stored in silicon precipitates around the thin film and on the negative electrode current collector 21, and the negative electrode active material layer 22 containing metallic lithium and silicon is thereby formed. The battery 100 in the present embodiment is thereby produced.

The charging in step S3 may be performed such that the ratio Ns/P of the charge capacity Ns of silicon per unit area of the negative electrode 20 to the charge capacity P per unit area of the positive electrode 10 satisfies 0.3≤Ns/P≤0.96. In this case, although lithium precipitates in the negative electrode 20, a short circuit between the negative electrode 20 and the positive electrode 10 due to metallic lithium precipitated in a dendritic form is prevented.

The charging in step S3 may be performed while pressure is applied to the laminated body. The direction of the pressure application is, for example, the same as the laminating direction of the layers of the laminated body. No particular limitation is imposed on the pressure applied to the laminated body. The pressure is, for example, higher than or equal to 0.5 MPa and lower than or equal to 300 MPa.

### EXAMPLES

The details of the present disclosure will be described by way of Examples. However, the battery of the disclosure is not limited to the following Examples. Production of negative electrode

An electrolytic method was used to precipitate copper on an electrolytic copper foil to roughen the surface thereof, and the resulting electrolytic copper foil was used as a negative electrode current collector. The thickness of the roughened electrolytic copper foil was 45 μm. Next, an RF sputtering device was used to form a silicon thin film on the negative electrode current collector. Argon gas was used for the sputtering. The pressure of the argon gas was 0.24 Pa. A negative electrode including the negative electrode current collector and the silicon thin film was thereby obtained. By adjusting the deposition time, six negative electrode samples (negative electrodes 1 to 6) with different silicon deposition amounts were produced. For each of the negative electrodes 1 to 6, the mass of silicon B_{Ns} (mg/cm²) contained in a unit area of the silicon thin film was determined. The results are shown in Table 1. The mass of silicon B_{Ns} (mg/cm²) contained in a unit area of the silicon thin film was determined by inductively coupled plasma emission spectrometry.

### Production of Solid Electrolyte

Li₂S raw material powder and P₂S₅ raw material powder were weighed in an argon glove box with a dew point lower than or equal to −60° C. such that their molar ratio was Li₂S:P₂S₅=75:25. The raw material powders were pulverized in a mortar and mixed to obtain a mixture. Then a planetary ball mill (type P-7 manufactured by Fritsch) was used to subject the mixture to milling treatment under the conditions of 510 rpm for 10 hours. A glass-like solid electrolyte was thereby obtained. The solid electrolyte obtained was subjected to heat treatment in an inert atmosphere under the conditions of 270° C. for 2 hours. Glass ceramic-like Li₂S—P₂S₅ serving as a sulfide solid electrolyte was thereby obtained.

### Production of Positive Electrode Mixture

LiNi_{0.8}Co_{0.1}Mn_{0.1}O₂ (hereinafter referred to as NCM) was used as a positive electrode active material. The NCM and Li₂S—P₂S₅ were mixed in a mortar such that their mass ratio was 85:15 to thereby obtain a positive electrode mixture.

### Production of Battery for Evaluation of Negative Electrode Capacity

80 mg of Li₂S—P₂S₅ was added to an electrically insulating cylinder having an inner diameter of 9.4 mm. Next, the negative electrode 3 punched to a diameter of 9.4 mm was added, and pressure forming was performed at 370 MPa. A laminated body including the negative electrode and the solid electrolyte layer was thereby produced.

Next, a metallic indium foil having a thickness of 200 μm, a metallic lithium foil having a thickness of 300 μm, and a metallic indium foil having a thickness of 200 μm were disposed in this other on the solid electrolyte layer of the laminated body. A three-laminated body including the negative electrode, the solid electrolyte layer, and the indium-lithium-indium layer was thereby produced. Next, the three-laminated body was subjected to pressure forming at 80 MPa. A two-electrode type electrochemical cell including the negative electrode serving as a working electrode and the indium-lithium-indium layer serving as a counter electrode was thereby produced. Next, current collectors containing stainless steel were disposed on the upper and lower sides of the electrochemical cell, and current collector leads were attached to the current collectors. An electrically insulating ferrule was used to seal and isolate the inside of the electrically insulating cylinder from the external environment. Four bolts were used to hold the electrochemical cell from the upper and lower sides to apply a pressure of 150 MPa. The thus-obtained half-cell is referred to as a battery for evaluation of negative electrode capacity.

### Charge-Discharge Test on Battery for Evaluation of Negative Electrode Capacity

A charge-discharge test was performed on the battery for evaluation of negative electrode capacity under the following conditions.

The battery for evaluation of negative electrode capacity was placed in a thermostatic oven at 25° C.

The battery for evaluation of negative electrode capacity was charged at a constant current of 0.08 mA. When the potential of the working electrode with respect to the counter electrode reached −0.62 V, the charging was terminated. Next, the battery was discharged at a current value of 0.08 mA, and the discharge was terminated at a voltage of 1.4 V. A value A_{Ns} obtained by converting the initial charge capacity to the charge capacity per unit mass of silicon was 3500 mAh/g. The product of the value A_{Ns} and the mass B_{Ns} (mg/cm²) of silicon contained in a unit area of the silicon thin film was used to determine the charge capacity Ns (mAh/cm²) of silicon per unit area of the negative electrode. The results are shown in Table 1.

For each of the negative electrodes 1, 2, and 4 to 6, a battery for evaluation of negative electrode capacity was produced using the same method as for the negative electrode 3. The charge-discharge test was performed on each of the batteries for evaluation of negative electrode capacity using the same method as for the negative electrode 3 to determine the charge capacity Ns (mAh/cm²) of silicon per unit area of the negative electrode. The results are shown in Table 1.

TABLE 1

| | Negative electrode sample No. | | | | | |
|---|---|---|---|---|---|---|
| | Negative | Negative | Negative | Negative | Negative | Negative |
| | electrode | electrode | electrode | electrode | electrode | electrode |
| | 1 | 2 | 3 | 4 | 5 | 6 |
| Thickness of electrolytic | 24 | 24 | 45 | 45 | 45 | 45 |
| copper foil (μm) | | | | | | |
| Mass B_{NS} of silicon | 0.161 | 0.445 | 0.656 | 1.101 | 1.188 | 1.299 |
| contained in unit area of | | | | | | |
| silicon thin film | | | | | | |
| (mg/cm²) | | | | | | |
| Charge capacity Ns of | 0.563 | 1.559 | 2.295 | 3.854 | 4.157 | 4.547 |
| silicon per unit area of | | | | | | |
| negative electrode | | | | | | |
| (mAh/cm²) | | | | | | |

### Production of Battery for Evaluation of Positive Electrode Capacity

80 mg of Li₂S—P₂S₅ was added to an electrically insulating cylinder having an inner diameter of 9.4 mm, and pressure forming was performed at 50 MPa. A solid electrolyte layer was thereby produced. Next, 16.8 mg of the positive electrode mixture was placed on one side of the solid electrolyte layer, and pressure forming was performed at 370 MPa. A laminated body including the positive electrode and the solid electrolyte layer was thereby produced.

Next, a metallic indium foil having a thickness of 200 μm, a metallic lithium foil having a thickness of 300 μm, and a metallic indium foil having a thickness of 200 μm were disposed in this other on the solid electrolyte layer of the laminated body. A three-laminated body including the positive electrode, the solid electrolyte layer, and the indium-lithium-indium layer was thereby produced. Next, the three-laminated body was subjected to pressure forming at 80 MPa. A two-electrode type electrochemical cell including the positive electrode serving as a working electrode and the indium-lithium-indium layer serving as a counter electrode was thereby produced. Next, current collectors containing stainless steel were disposed on the upper and lower sides of the electrochemical cell, and current collector leads were attached to the current collectors. An electrically insulating ferrule was used to seal and isolate the inside of the electrically insulating cylinder from the external environment. Four bolts were used to hold the electrochemical cell from the upper and lower sides to apply a pressure of 150 MPa. The thus-obtained half-cell is referred to as a battery for evaluation of positive electrode capacity.

### Charge-Discharge Test on Battery for Evaluation of Positive Electrode Capacity

The charge-discharge test was performed on the battery for evaluation of positive electrode capacity under the following conditions.

The battery for evaluation of positive electrode capacity was placed in a thermostatic oven at 25° C.

The battery for evaluation of positive electrode capacity was charged at a constant current of 0.143 mA. When the potential of the working electrode with respect to the counter electrode reached 3.7 V, the charging was terminated. Next, the battery was discharged at a current value of 0.143 mA, and the discharge was terminated at a voltage of 1.85 V. A value obtained by converting the initial charge capacity to the charge capacity per unit area of the positive electrode was 4.33 mAh/cm².

### Production of Battery

80 mg of Li₂S—P₂S₅ was added to an electrically insulating cylinder having an inner diameter of 9.4 mm, and pressure forming was performed at 50 MPa. A solid electrolyte layer was thereby produced. Next, 16.8 mg of the positive electrode mixture was placed on one side of the solid electrolyte layer, and the negative electrode 3 punched to a diameter of 9.4 mm was placed on the other side of the solid electrolyte layer. The resulting product was subjected to pressure forming at 370 MPa. A laminated body including the positive electrode, the solid electrolyte layer, and the negative electrode was thereby produced. Next, current collectors containing stainless steel were placed on the positive and negative electrodes, and then current collector leads were attached to the current collectors. An electrically insulating ferrule was used to seal and isolate the inside of the electrically insulating cylinder from the external environment. Four bolts were used to hold the laminated body from the upper and lower sides to apply a pressure of 12 MPa. A battery 3 including the negative electrode 3 was thereby obtained.

A battery 1 including the negative electrode 1, a battery 2 including the negative electrode 2, a battery 4 including the negative electrode 4, a battery 5 including the negative electrode 5, and a battery 6 including the negative electrode 6 were produced using the same procedure as that for the battery 3 except that the thickness of the electrolytic copper foil and the mass B_{Ns} of silicon contained in a unit area of the silicon thin film were adjusted to the conditions shown in Table 1.

The ratio Ns/P of each of the batteries 1 to 6 was determined by the method described above. Specifically, the ratio Ns/P was determined by dividing the charge capacity Ns (mAh/cm²) of silicon per unit area of the negative electrode by the charge capacity P (mAh/cm²) per unit area of the positive electrode. More specifically, the ratio Ns/P was determined by dividing the product of B_{Ns} (mg/cm²) and A_{Ns} (mAh/g) by the product of B_{P} (mg/cm²) and A_{P} (mAh/g). B_{Ns} (mg/cm²) is the mass of silicon contained in a unit area of the silicon thin film. A_{Ns} (mAh/g) is a value determined previously and obtained by converting the initial charge capacity to the charge capacity per unit mass of silicon and is 3500 mAh/g. B_{P} (mg/cm²) is the mass of NCM contained in a unit area of the positive electrode. A_{P} (mAh/g) is a value determined previously and obtained by converting the initial charge capacity to the charge capacity per unit mass of NCM and is 210 mAh/g. The results are shown in Table 2.

### Charge-Discharge Test

A charge-discharge test was performed on the battery 3 under the following conditions. The charge-discharge test was performed with the battery 3 placed in a thermostatic oven at 25° C.

### Evaluation of Initial Discharge Capacity

The battery 3 was charged at a constant current value corresponding to 20 hour rate (0.05 C rate) to a voltage of 4.2 V. Next, the battery 3 was discharged at a current value corresponding to 0.05 C rate to 2.0 V.

The product of the obtained initial discharge capacity (mAh) and the average discharge voltage (V) was divided by the mass of the positive electrode active material to compute the energy density u (Wh/kg) per unit mass of the positive electrode active material. The results are shown in Table 2.

For each of the batteries 1, 2, and 4 to 6, the energy density u (Wh/kg) per unit mass of the positive electrode active material was computed using the same method as that for the battery 3. The results are shown in Table 2.

### Evaluation of Cycle Characteristics

Next, the charge-discharge cycle characteristics of the battery 3 used to evaluate the initial discharge capacity were evaluated. More specifically, the battery 3 was first charged at a constant current corresponding to 0.05 C rate to 4.25 V, then discharged at a constant current corresponding to 0.05 C rate to 2.0 V, and further discharged at 0.01 C to 2.0 V. This charge-discharge cycle was repeated 10 times. The ratio of the discharge capacity at the tenth cycle to the discharge capacity at the first cycle at the start of the cycle evaluation was determined as the retention rate of discharge capacity. The results are shown in Table 2.

For each of the batteries 1, 2, and 4 to 6, the retention rate of discharge capacity was determined by the same method as that for the battery 3. The results are shown in Table 2.

TABLE 2

| | Battery No. | | | | | |
|---|---|---|---|---|---|---|
| | Battery 1 | Battery 2 | Battery 3 | Battery 4 | Battery 5 | Battery 6 |
| | Negative electrode sample No. | | | | | |
| | Negative | Negative | Negative | Negative | Negative | Negative |
| | electrode | electrode | electrode | electrode | electrode | electrode |
| | 1 | 2 | 3 | 4 | 5 | 6 |
| Ratio Ns/P | 0.13 | 0.36 | 0.53 | 0.89 | 0.96 | 1.05 |
| Energy density u | 710 | 694 | 669 | 658 | 634 | 618 |
| (Wh/kg-positive electrode) | | | | | | |
| Discharge capacity retention | 84.2 | 90.7 | 95.1 | 96.5 | 94 | 93.2 |
| rate (%) | | | | | | |

### DISCUSSION

As shown in Table 2, in the batteries 2 to 5, 0.3≤Ns/P≤0.96 is satisfied, and the batteries obtained have a suitable balance between energy density and cycle characteristics. Specifically, in the batteries 2 to 5, the ratio of metallic lithium precipitated in a dendritic form was reduced while the ratio of silicon having the lithium occlusion ability and contained in the negative electrode was maintained, and therefore a short circuit was avoided. Moreover, while a reduction in the energy density u per unit mass of the positive electrode active material was prevented, the discharge capacity retention rate at the tenth cycle was improved to higher than or equal to 90%, and high cycle characteristics were achieved. This may be because silicon and the precipitated metallic lithium function as the negative electrode active material and because silicon serves as a filler in the negative electrode and the metallic lithium precipitated around silicon serves as an electron conducting material. In particular, in the batteries 3 to 5 satisfying 0.5≤Ns/P≤0.96, the discharge capacity retention rate at the tenth cycle was improved to higher than or equal to 94%, and higher cycle characteristics were achieved. In the batteries 3 and 4 satisfying 0.5≤Ns/P≤0.90, the discharge capacity retention rate at the tenth cycle was improved to higher than or equal to 95%, and even higher cycle characteristics were achieved.

In the battery 1, the ratio Ns/P is less than 0.3, and the ratio of metallic lithium is highest. Even when the battery 1 was charged at 0.1 C rate (10 hour rate), a short circuit occurred. This may be due to the precipitation of dendritic metallic lithium because the ratio of metallic lithium is high. In the battery 6, the ratio Ns/P is more than 0.96, and the ratio of silicon is highest. Since the ratio of the capacity derived from metallic lithium to the capacity of the battery was low, the average discharge voltage was low, and the energy density u per unit mass of the positive electrode active material was low. The discharge capacity retention rate of the battery 6 was lower than that of the battery 4. This may be because of the following reason. Since the capacity derived from silicon in the negative electrode active material occupies most of the battery capacity, the risk of a short circuit was reduced. However, since the ratio of metallic lithium precipitated around silicon is small, the function of the metallic lithium as the electron conducting material was reduced.

As shown in the Examples, by controlling the ratios of metallic lithium and silicon contained in the negative electrode within the specific ranges, the battery obtained can have a suitable balance between energy density and cycle characteristics.

The battery of the disclosure can be used, for example, for vehicle-mounted lithium ion secondary batteries

What is claimed is:

1. A production method for a battery comprising:
depositing silicon on a negative electrode current collector to produce a negative electrode;
producing a laminated body including the negative electrode, a solid electrolyte layer, and a positive electrode in this order; and
charging the laminated body to cause metallic lithium to precipitate in the negative electrode.

2. The production method for a battery according to claim 1, wherein the ratio Ns/P of the charge capacity Ns of the silicon per unit area of the negative electrode to the charge capacity P per unit area of the positive electrode satisfies 0.3≤Ns/P≤0.96.

3. The production method for a battery according to claim 2, wherein the ratio Ns/P satisfies 0.5≤Ns/P.

4. The production method for a battery according to claim 2, wherein the ratio Ns/P satisfies Ns/P≤0.9.

5. The production method for a battery according to claim 1, wherein the negative electrode includes a negative electrode active material layer located between the negative electrode current collector and the solid electrolyte layer, and
wherein the negative electrode active material layer has a structure in which a plurality of silicon particles are disposed along a surface of the negative electrode current collector so as to cover the surface of the negative electrode current collector.

6. The production method for a battery according to claim 5, wherein the silicon particles are in a columnar form.

7. The production method for a battery according to claim 1, wherein the solid electrolyte layer contains a solid electrolyte having lithium ion conductivity.

8. The production method for a battery according to claim 7, wherein the solid electrolyte contains a sulfide solid electrolyte.

9. A method of using a battery, the method comprising:
charging a battery including a laminated body including a negative electrode prepared by depositing silicon on a negative electrode current collector, a solid electrolyte layer, and a positive electrode in this order to thereby cause metallic lithium to precipitate in the negative electrode.

10. The method of using a battery according to claim 9, wherein the ratio Ns/P of the charge capacity Ns of the silicon per unit area of the negative electrode to the charge capacity P per unit area of the positive electrode satisfies 0.3≤Ns/P≤0.96.

11. The method of using a battery according to claim 10, wherein the ratio Ns/P satisfies 0.5≤Ns/P.

12. The method of using a battery according to claim 10, wherein the ratio Ns/P satisfies Ns/P≤0.9.

13. The method of using a battery according to claim 9, wherein the negative electrode includes a negative electrode active material layer located between the negative electrode current collector and the solid electrolyte layer, and
wherein the negative electrode active material layer has a structure in which a plurality of silicon particles are disposed along a surface of the negative electrode current collector so as to cover the surface of the negative electrode current collector.

14. The method of using a battery according to claim 13, wherein the silicon particles are in a columnar form.

15. A battery comprising:
a positive electrode;
a negative electrode, and
a solid electrolyte layer located between the positive electrode and the negative electrode,
wherein the positive electrode contains a positive electrode active material containing lithium,
wherein the negative electrode contains a negative electrode active material containing metallic lithium and silicon, and
wherein the ratio Ns/P of the charge capacity Ns of the silicon per unit area of the negative electrode to the charge capacity P per unit area of the positive electrode satisfies 0.3≤Ns/P≤0.96.

16. The battery according to claim 15, wherein the negative electrode includes a negative electrode current collector and a negative electrode active material layer located between the negative electrode current collector and the solid electrolyte layer, and
wherein the negative electrode active material layer has a structure in which a plurality of silicon particles are disposed along a surface of the negative electrode current collector so as to cover the surface of the negative electrode current collector.

17. The battery according to claim 15, wherein the metallic lithium precipitates during charging.
